(19) United States
(12) Patent Application Publication
(10) Pub. No.: US 2013/0299277 A1
(43) Pub. Date: Nov. 14, 2013

(54) Optimized Wind Turbine Tower with Mountings for Tower Internals

(71) Applicants: Vishal Kyatham, Redlands, CA (US); Dereck Petch, Longmont, CO (US); Nestor A. Agbayani, Bakersfield, CA (US)

(72) Inventors: Vishal Kyatham, Redlands, CA (US); Dereck Petch, Longmont, CO (US); Nestor A. Agbayani, Bakersfield, CA (US)

(73) Assignee: Clipper Windpower, Inc., Carpinteria, CA (US)

(21) Appl. No.: 13/469,962

(22) Filed: May 11, 2012

(51) Int. Cl. F03D 11/04; F21V 21/00; E06C 9/02; H02G 3/02

(52) U.S. Cl. 182/129; 248/201; 248/73

(57) ABSTRACT

A wind turbine tower for mounting tower internals is disclosed. The wind turbine tower may include a plurality of tower sections and each of the tower sections may comprise a plurality of cans axially joined together, the plurality of cans including a top can and a bottom can and intermediate cans. Each wind turbine tower section may further include a top flange attached to the top can and a bottom flange attached to the bottom can. Brackets for supporting the tower internals are welded to the inside wall of each tower section, but the welded brackets are restricted to only the top one or two cans, and the bottom one or two cans, while a the remainder of the intermediate cans do not have any brackets welded thereto. The intermediate cans without any welded brackets may be fabricated of steel plate that is less thick, and therefore less costly.

### FIELD OF THE DISCLOSURE

The present disclosure generally relates to wind turbines and, more particularly, relates to wind turbine towers for optimized mounting of tower internal components.

### BACKGROUND OF THE DISCLOSURE

A utility-scale wind turbine typically includes a set of two or three large rotor blades mounted to a rotor hub. The rotor blades and the rotor hub together are referred to as the rotor. The rotor blades aerodynamically interact with the wind and create lift, which is then translated into a driving torque by the rotor. The rotor is attached to and drives a main shaft, which in turn is operatively connected via a drive train to a generator or a set of generators that produce electric power. The main shaft, the drive train and the generator(s) may all be situated within a nacelle, which in turn is situated on top of a wind turbine tower.

The most common type of wind turbine tower today is a steel tube tower constructed of several individual tower sections. Each tower section is essentially a steel shell attached to internal top and bottom flanges, and the top flange of one section is bolted to the bottom flange of an adjacent section to form the tower. While typically a wind turbine tower is composed of three or four tower sections, the number of tower sections may vary depending upon the hub height of the wind turbine tower.

Inside the wind turbine tower are tower internals that may include a ladder, a lift, platforms spaced at various tower heights, lights, and electrical conduits and wires. The platforms may be provided just below each flange joint between tower sections and are primarily provided as a working surface for technicians to complete the flange bolted joints during construction of the tower, and to inspect and service these bolted joints throughout the tower's life. The ladder extends from the bottom of the tower to the top and is the means by which technicians reach the nacelle on top of the tower. Various wires and electrical cables also run up and down the tower.

The tower internals are typically supported by brackets that are welded to the inside surface (e.g., the inside wall) of the wind turbine tower. The brackets for all of the platforms, cable trays and other wire attachments, the ladder, the lights, etc., can add up to a lot of brackets to weld to the inside of the wind turbine tower. Each welded bracket reduces the fatigue strength of the steel shell of the wind turbine tower. In order to account for the reduced fatigue strength due to the welded brackets, the steel shell has to be of an increased thickness to meet certain design requirements and to effectively resist wind turbine loads. The thicker the steel shell is, the more expensive it is and the more it weighs, adding to the overall weight and cost of the wind turbine.

Accordingly, it would be beneficial if a mechanism to effectively mount tower internals within a wind turbine tower without compromising its strength is developed. It would additionally be beneficial if such a mechanism is cost effective and weighs less relative to existing mechanisms in traditional wind turbine towers.

### SUMMARY OF THE DISCLOSURE

In accordance with one aspect of the present disclosure, a tubular wind turbine tower section is disclosed. The tubular wind turbine tower section may comprise a top flange, a bottom flange, a bottom can attached to the bottom flange, a top can attached to the top flange, a plurality of intermediate cans axially joined together between and attached to the bottom can and the top can, and a plurality of support brackets welded to the top can and the bottom cans. At least some of the intermediate cans may have a thickness less than the thickness of the top can, and no support brackets are welded to said intermediate cans.

In accordance with another aspect of the present disclosure, a wind turbine tower section is disclosed. The wind turbine tower section may comprise a top flange, a bottom flange, a bottom can attached to the bottom flange, a top can attached to the top flange, a plurality of intermediate cans axially joined together between and attached to the bottom can and the top can, and a support system for supporting tower internals inside of the tower section. The support system may be attached to support brackets mounted to the top can and the bottom can. No support brackets are welded to the intermediate cans.

In accordance with yet another aspect of the present disclosure, a tubular wind turbine tower section is disclosed. The tubular wind turbine tower section may comprise a top flange, a bottom flange, a bottom can attached to the bottom flange, a top can attached to the top flange, a plurality of intermediate cans axially joined together between and attached to the bottom can and the top can, and a plurality of support brackets welded to the top can and the bottom cans. No support brackets are welded to at least some of the intermediate cans, and each of the intermediate cans without welded support brackets may have a thickness less than the thickness of said intermediate can if said can had a support bracket welded to it.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is a schematic illustration of a wind turbine tower employed with the wind turbine of FIG. 1, and further showing a schematic exploded view of two of the tower sections of the wind turbine tower;

FIG. 3A is a partial perspective view of two tower sections of a wind turbine tower;

FIG. 3B is an enlarged view of the bottom of the wind turbine tower of FIG. 3A;

FIG. 3C is an enlarged view of a middle portion of the wind turbine tower of FIG. 3A showing the two tower sections joined together by flanges;

FIG. 3D is an enlarged view of a portion of the wind turbine tower of FIG. 3A showing attachment of the support system to the intermediate cans;

FIG. 3E is an enlarged view of the top of the wind turbine tower of FIG. 3A; and

FIG. 4 is a top view of a wind turbine tower section.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

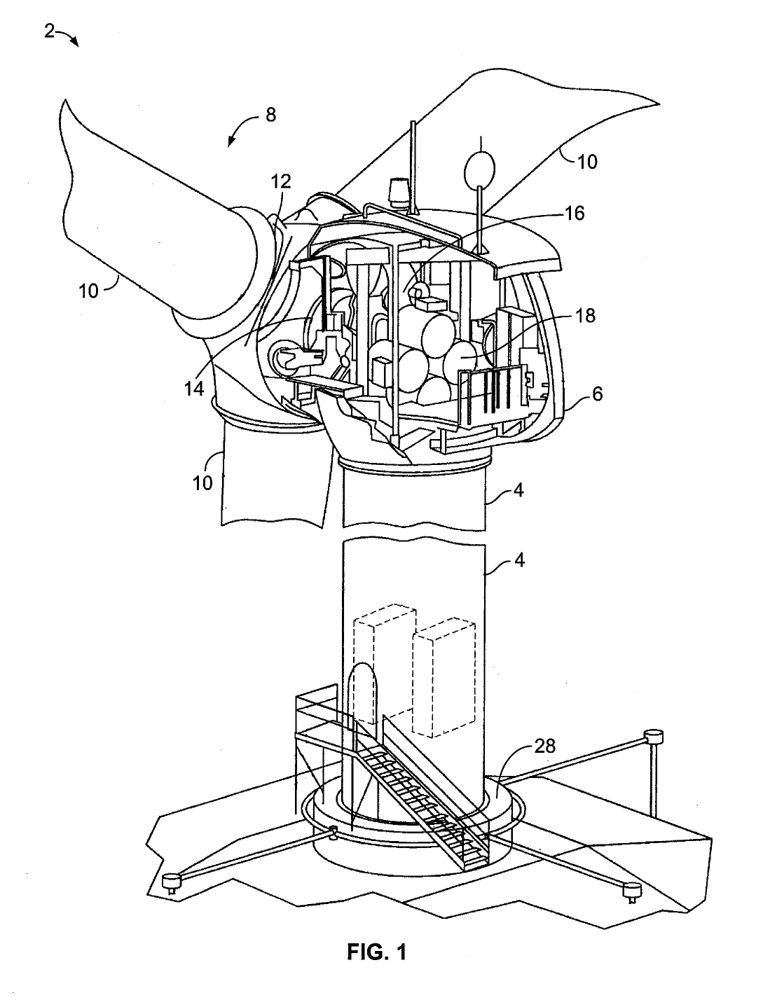

Referring to FIG. 1, an exemplary wind turbine 2 is shown, in accordance with at least some embodiments of the present disclosure. While all the components of the wind turbine have not been shown and/or described, a typical wind turbine may include a wind turbine tower 4 and a nacelle 6 mounted on top of the wind turbine tower. The wind turbine 2 may also include a rotor 8 having a plurality of rotor blades 10 connected to a hub 12. The rotor blades 10 may rotate with wind energy and the rotor 8 may transfer that energy to a main shaft 14 situated within the nacelle 6. The nacelle 6 may additionally house several other components including, but not limited to, a drive train 16 connecting the main shaft 14 on one end to one or more generators 18 on the other end.

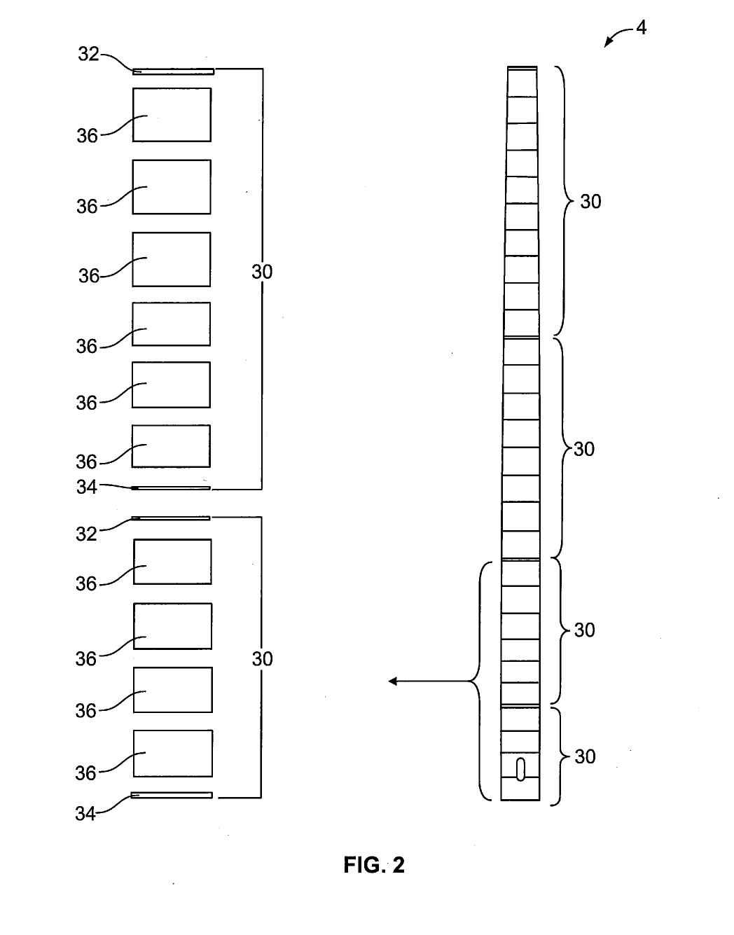

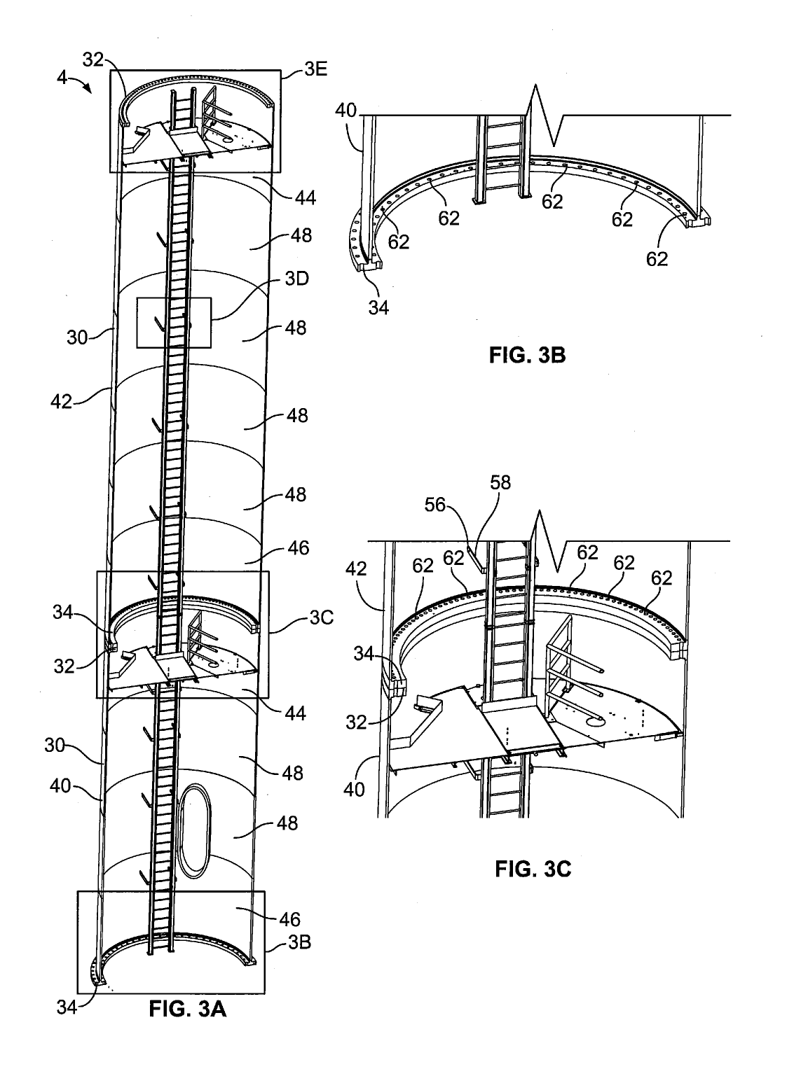

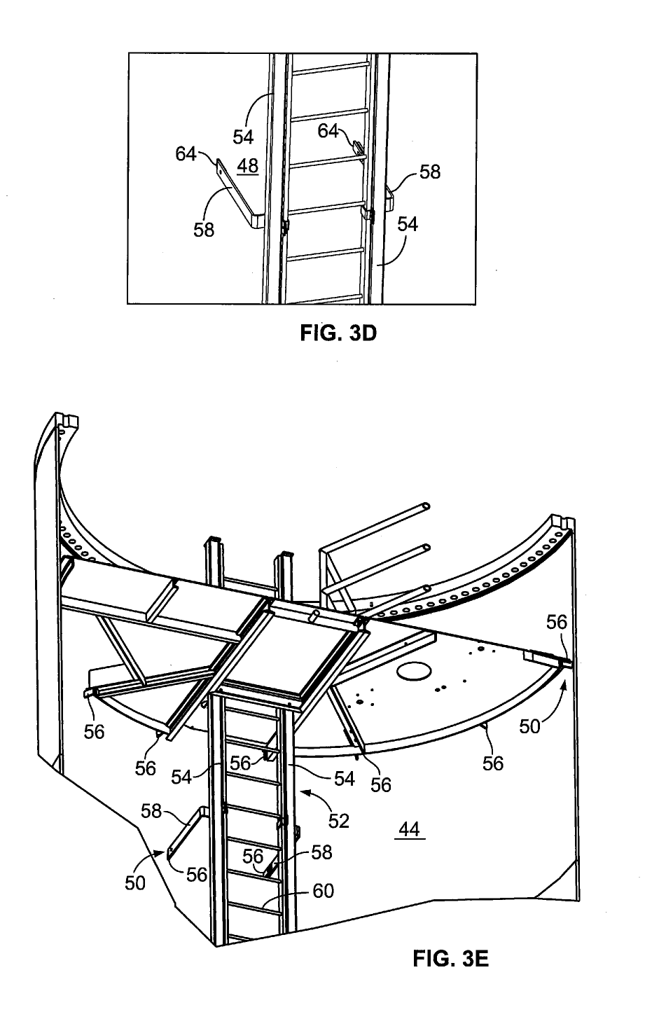

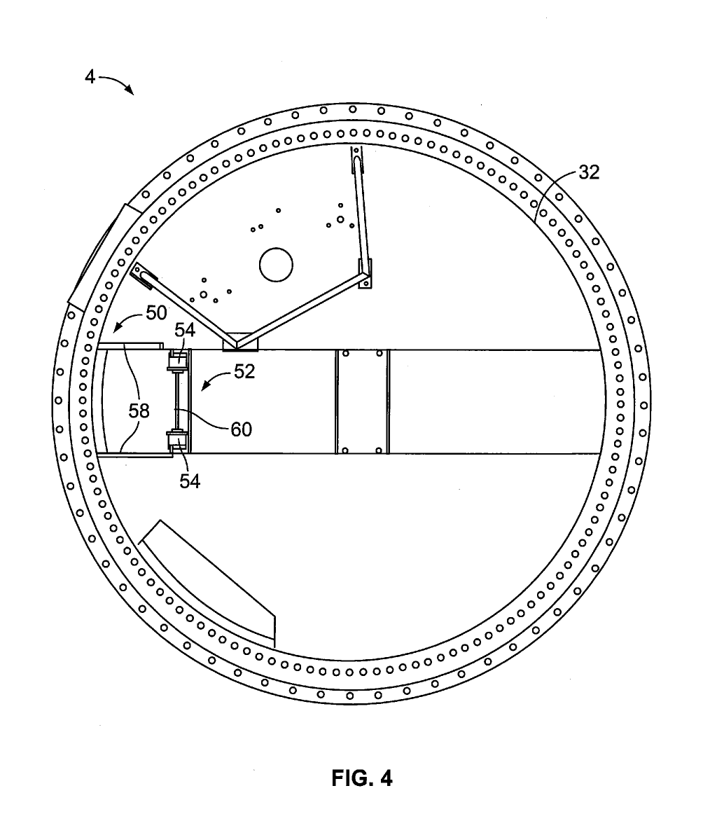

Ladders, platforms, lights, electrical conduits, and several other components may be mounted within the wind turbine tower 4, in a manner described in FIGS. 3A and 4. Furthermore, the wind turbine tower 4 may be erected from or otherwise may rest upon a base foundation 28. The structure and construction of the wind turbine tower 4 is explained in greater detail in FIG. 2.

Turning now to FIG. 2, an exemplary schematic illustration of the wind turbine tower 4 is shown, in accordance with at least some embodiments of the present disclosure. As shown, the wind turbine tower 4 may be constructed of multiple tower sections 30. In at least some embodiments, each of the tower sections 30 may be approximately five to forty meters (5-40 m) high, although other height tower sections are conceivable. Additionally, while only four (4) substantially cylindrical tower sections 30 have been shown, in at least some embodiments, the number of tower sections may vary. Furthermore, each of the tower sections 30 may be substantially oval in shape or assume other geometries such as frustoconical or polygonal.

Each of the tower sections 30 may include a top flange 32 and a bottom flange 34, for mounting to adjacent tower sections, the base foundation 28 (e.g., the bottom flange of the bottommost tower section may be connected to the base foundation), or the nacelle 6 (e.g., the top flange of the topmost tower section may be connected to the nacelle). Between the top flange 32 and the bottom flange 34 of each individual tower section 30 may be multiple shells or cans 36 that may be welded (or connected by other mechanisms) at their axial ends to one another or to one of the top or the bottom flanges to form each tower section. Each of the cans 36 may be constructed of a single piece of steel plate bent, formed, or rolled into a substantially cylindrical (or other) shape and welded on its ends. Other materials or alloys may also be suitable for constructing the wind turbine tower 4 in addition to steel plate.

The thickness of the steel plate and the resulting thickness of the cans 36 constructed from that steel plate may be selected according to established design principles. To reduce weight and cost, the cans 36 that have internal components welded to them may be made of thicker steel plates compared to the cans that have no additional welding aside from the longitudinal and circumferential welds that are used to join the cans. Specifically, inside the wind turbine tower 4 are disposed various components generically referred to as tower internals. These tower internals may include ladders, lifts and platforms for maintenance and for reaching the nacelle 6, cables for power transmission and controls, lighting, etc., all of which may be mounted to and/or supported by the inside walls of the cans 36 through welding. For example, a ladder may be fixed to brackets, which in turn may be welded to the inside walls of one or more of the cans 36. One of the design variables that affects the thickness of the steel plate required for constructing the cans 36 is the effect of welding. For a given load on, the wind turbine tower 4, the addition of welds at various locations on the inner walls of the cans 36 reduces the fatigue strength of the can walls, which increases the thickness requirement. The welding of a bracket, for example, to the inner wall of the cans 36 not only creates stress risers and changes the metallurgy of the parent material (e.g., steel plate) in the heat affected zone, it also applies additional point loads to the tower wall, etc. All of these effects increase the need for the steel plate of the cans 36 to be thicker in order to meet the design requirements.

In order to reduce weight and cost of the wind turbine tower 4 (and the wind turbine 2), the present disclosure proposes that the welding of tower internals to the cans 36 be limited to only certain cans of each tower section 30 so that only the cans having welding will be made of thicker steel plates, while the remaining ones of the cans may be made of thinner steel plates.

Referring now to FIGS. 3A and 4, partial perspective and top views, respectively, of the wind turbine tower 4 and particularly, the tower sections 30 of the wind turbine tower are shown, in accordance with at least some embodiments of the present disclosure. For simplicity of explanation, the present disclosure has been described below with respect to the bottom two wind turbine tower sections 40 and 42. Nevertheless, it will be understood that the teachings of this disclosure are equally applicable to all of the tower sections 30 of the wind turbine tower 4. Furthermore, the tower section 42 has been shown as being composed of six cans 36. This is merely exemplary, and a stack of up to about four to fifteen (4-15) cans is possible.

The tower section 40 may be mounted via its bottom flange 34 to the base foundation 28. As shown best in FIG. 3B, the bottom flange 34 may comprise a T-shaped flange with a pattern of bolt holes 62 for bolting the bottom flange 34 to the base foundation. The bottom flange 34 of the tower section 40 may have an inner diameter which is smaller than the diameter of the cans 36 and may have an outer diameter which is larger than the diameter of the cans 36 to increase structural support of the wind turbine tower 4. In another arrangement, the bottom flange 34 may comprise an L-shaped flange. The bottom flange 34 of the tower section 42 may be mounted to the top flange 32 of the tower section 40, and the bottom flange of an adjacent tower section 30 may be mounted to the top flange 32 of the tower section 42, and so on. As shown best in FIG. 3C, the top and bottom flanges 32, 34 may comprise L-shaped flanges for axial joining of the adjacent tower sections 40 and 42. Each top and bottom flange 32, 34 may have a pattern of bolt holes 62 for bolting the top and bottom flanges 32, 34 together or for bolting the flange to the nacelle. Other means for securing the flanges 32, 34 are certainly possible. The flanges 32, 34 may also have an inner diameter which is smaller than the diameter of the cans 36 for increased structural support for mounting adjacent tower sections 30.

The thickness of each of the cans 36 within the tower sections 40 and 42 may be customized to reduce weight of the wind turbine tower 4 and the cost of the steel plate making up those cans. Specifically, the steel plate of the cans 36 that do not have any welding from mounting of tower internals on their inner walls may be thinner, cheaper and lighter than the steel plate of the cans which do have any internal welding (from mounting tower internals).

In at least some embodiments and, as shown, the tower internals may be attached only to a top can 44 and a bottom can 46 within each of the tower sections 40 and 42. For the top can 44 and the bottom can 46, the steel plate employed for constructing those cans may be thicker to permit welding and meet all design requirements, while all intermediate cans 48 (which have no welding) may be constructed of thinner steel plate that is not thick enough to permit welding but yet meets all design requirements. In order to facilitate attachment of the tower internals to the top can 44 and the bottom can 46, a plurality of support brackets 50 welded to the top and the bottom cans and/or a support system 52 supported by the support brackets may be employed. Both the support brackets 50 and the support system 52 are described below.

With respect to the support system 52, it may include one or more tubes (e.g., rectangular tubes) or rods 54 that may be connected (e.g., by bolts) to and supported by the support brackets 50 welded to the top can 44 and the bottom can 46 of each of the tower sections 40 and 42. In addition to tubes or rods, truss sub-assemblies or cables may also be possible instead of rods 54. While two (See FIG. 4) of the tubes 54 have been shown in the present embodiment, the number of tubes in other embodiments may vary depending upon the desired positioning of the tower internals within the wind turbine tower 4. The tubes 54 may run basically from the top can 44 to the bottom can 46, or from near the top flange 32 to near the bottom flange 34, of each tower section.

The support system 52 may be supported by way of the support brackets 50 welded to the inner walls of one or both of the top can 44 and the bottom can 46 of each tower section. As shown specifically in FIGS. 3E and 4, the support brackets 50 may include a welded bracket 56 that may be welded to the top and/or the bottom cans 44 and 46, respectively. The welded bracket 56 may be connected to connecting brackets 58, which in turn may be connected to the tubes 54 to provide support thereto. As shown specifically in FIG. 3D, between the top can 44 and the bottom can 46, the tubes 54 may be self-supported, or, if desired, may be supported by additional attachment means which provide mostly lateral support against swaying, and which do not involve welding, such as brackets 64 attached via magnets or glue or other means to the inner walls of the intermediate cans 48. The brackets 64, which are attached to the intermediate cans' 48 inner surface via magnets, glue, or other means except for welding, may then be connected to connecting brackets 58 to support the tubes 54.

The support system 52 can function as a “backbone” inside the tower for the attachment of and support of tower internals, and structures other than those illustrated or described could constitute this backbone. Together the support brackets 50 and the support system 52 may be employed as attachment points to support the various tower internals, such as, one or more ladders 60, buss bars, cables, outlets, lights, platforms and other components (not shown). Similar to the tubes 54, some of the tower internals may additionally be supported laterally against swaying, if necessary, by utilizing brackets attached to the inner walls of the intermediate cans 48 by ways other than welding such as bolts, glue or magnets.

By virtue of using only the top can 44 and the bottom can 46 for welding, these cans may be constructed of thicker steel plates compared to steel plates of the intermediate cans 48, thereby facilitating a reduced weight and cheaper wind turbine tower 4. Each can without welding of support brackets for mounting tower internals may have a reduced thickness, less than the thickness would have been if there were attachment points welded to it. The cans with welding of support brackets for mounting tower internals may advantageously include only the top can 44 and the bottom can 46. Any one or more of the intermediate cans 48 may also have welding of support brackets for mounting tower internals, if necessary. By designing a wind turbine tower having each of its tower sections with this can configuration, the overall weight and cost of construction is lowered, while maintaining the fatigue strength of the wind turbine tower.

Thus, depending upon the size and weight of the various tower internals, the thickness of the cans 36 in any given tower section 30 may be customized to have thicker steel plates where welding is desired and thinner steel plates in all remaining cans. Furthermore, each of the tower sections 30 may be individually customized depending upon the requirements of the tower internals mounted therein. For example, one tower section may have only the top and the bottom cans 44 and 46, respectively, with increased thickness, while another tower section may have top two and bottom two cans with increased thickness, and so on.

Thus, the present disclosure sets forth a wind turbine tower with customized thickness of cans or shells composing each of the plurality of tower sections. The cans having tower internals mounted (e.g., welded) thereon may be constructed of thicker steel plates while the cans with no welding may be constructed of thinner steel plates to save cost and to reduce the overall weight of the wind turbine tower without compromising the fatigue strength of the wind turbine tower while meeting all design requirements.

While only certain embodiments have been set forth, alternatives and modifications will be apparent from the above description to those skilled in the art. These and other alternatives are considered equivalents and within the spirit and scope of this disclosure and the appended claims.

We claim:

1. A tubular wind turbine tower section comprising:
a top flange;
a bottom flange;
a bottom can attached to the bottom flange;
a top can attached to the top flange;
a plurality of intermediate cans axially joined together between and attached to the bottom can and the top can;
a plurality of support brackets welded to the top can and the bottom cans; and
wherein at least some of the intermediate cans have a thickness less than the thickness of the top can, and no support brackets are welded to said intermediate cans.

2. The tubular wind turbine tower section of claim 1, wherein the plurality of support brackets are attached to a support system for supporting tower internals inside of the tubular wind turbine tower section.

3. The tubular wind turbine tower section of claim 2, wherein the support system comprises a set of tubes running parallel to one another and longitudinally along the length of the tubular wind turbine tower section.

4. The tubular wind turbine tower section of claim 3, wherein each of the set of tubes is rectangular or round.

5. The tubular wind turbine tower section of claim 4, wherein a ladder is formed between the set of parallel tubes.

6. The tubular wind turbine tower section of claim 2, wherein the tower internals comprise buss bars, electric cables, lights and outlets.

7. The tubular wind turbine tower section of claim 2, further comprising a plurality of lateral support brackets to support the support system, the plurality of lateral support brackets attached to the intermediate cans through means other than welding.

8. The tubular wind turbine tower section of claim 7, wherein the plurality of lateral support brackets are attached to the intermediate cans by gluing or magnets.

9. A wind turbine tower section comprising:
a top flange;
a bottom flange;
a bottom can attached to the bottom flange;
a top can attached to the top flange;
a plurality of intermediate cans axially joined together between and attached to the bottom can and the top can;
a support system for supporting tower internals inside of the tower section, the support system attached to support brackets mounted to the top can and the bottom can; and
wherein no support brackets are welded to the intermediate cans.

10. The wind turbine tower section of claim 9, further comprising a plurality of lateral support brackets to support the support system, the plurality of lateral support brackets attached to the intermediate cans through means other than welding.

11. The wind turbine tower section of claim 10, wherein the plurality of lateral support brackets are attached to the intermediate cans by gluing or magnets.

12. The wind turbine tower section of claim 11, wherein the support system comprises a set of tubes running parallel to one another and longitudinally along the length of the wind turbine tower section.

13. The wind turbine tower section of claim 12, wherein each of the set of tubes is rectangular or round.

14. The wind turbine tower section of claim 13, wherein a ladder is formed between the set of parallel tubes.

15. A tubular wind turbine tower section comprising:
a top flange;
a bottom flange;
a bottom can attached to the bottom flange;
a top can attached to the top flange;
a plurality of intermediate cans axially joined together between and attached to the bottom can and the top can;
a plurality of support brackets welded to the top can and the bottom cans; and
wherein no support brackets are welded to at least some of the intermediate cans, and each of the intermediate cans without welded support brackets has a thickness less than the thickness of said intermediate can if said can had a support bracket welded to it.
